(19) United States
(12) Patent Application Publication
(10) Pub. No.: US 2012/0084134 A1
(43) Pub. Date: Apr. 5, 2012

(54) Energy Conservation Incentivisation System

(76) Inventor: Paul Conrady, Edmond, OK (US)

(21) Appl. No.: 13/232,675

(22) Filed: Sep. 14, 2011

Related U.S. Application Data
(60) Provisional application No. 61/382,620, filed on Sep. 14, 2010.

(51) Int. Cl. G06Q 30/02

(52) U.S. Cl. 705/14.36

(57) ABSTRACT

An energy conservation incentivisation system is disclosed. The energy conservation incentivisation system is provided with a website having a web server reading information representative of a customer's energy usage for a given period of time in relation to a corresponding period of time. The website verifies a reduction of energy usage, and registers the customer in a rewards program. The energy conservation incentivisation system also includes a communication system communicating with the Internet using an Internet protocol to receive the information from the customer. The information representative of the customer's energy usage can be one or more electronic files of utility invoices from the given period of time and the corresponding period of time.

### CROSS-REFERENCE TO RELATED APPLICATIONS

The present patent application claims priority to the provisional patent application identified by U.S. Ser. No. 61/382,620, filed on Sep. 14, 2010, the entire content of which is hereby incorporated herein by reference.

### FIELD OF THE INVENTION

The presently disclosed invention is directed to an energy conservation incentivisation system wherein a customer is rewarded when their total energy usage, i.e., electricity usage, water usage, natural gas usage, petroleum usage, i.e., diesel, gasoline and liquefied petroleum gas, and the like, for a predetermined period of time is less than their energy usage for a previous predetermined time period, the rewarded customer is qualified for rewards, prizes, discounts and the like.

### BACKGROUND OF THE INVENTION

Energy conservation is the practice of decreasing the quantity of energy used. It may be achieved through efficient energy use, in which case energy use is decreased while achieving a similar outcome, or by reduced usage of energy services. Energy conservation may result in increase of financial capital, environmental value, national security, personal security, and human comfort. Individuals and organizations that are direct consumers of energy may want to conserve energy in order to reduce energy costs and promote economic security. Industrial and commercial users may want to increase efficiency and thus maximize profit.

Various methods and processes have been proposed which deal with incentivizing particular behaviors relating to energy usage. For example, U.S. Patent Application Publication No. 2002/0116266 A1, to Marshall is directed to a method and system for tracking and providing incentives for “time” and “attention” of persons and for timing the performance of tasks. Generally, Marshall teaches a method to induce a person to either pay their bills early (the “time” component) and/or be at a certain place at a certain time (the “attention” component). Marshall further discusses providing incentives to customers to alter their energy usage timing, i.e., from peak to off-peak periods. However, Marshall fails to incentivize a reduction in the total usage of energy.

Further, U.S. Pat. No. 6,532,448, issued to Higginson et al. discloses a contest server generally. However, Higginson et al. does not teach utilization of the contest server as an incentivisation component to reduce the total usage of energy.

Therefore, a need exists for a system wherein an energy customer can provide information indicative of their energy usage for a period of time and also comparison information for a corresponding period of time in order to demonstrate a reduction in energy usage wherein the information provided by the customer demonstrating energy conservation registers the customer for a rewards program.

### SUMMARY OF THE INVENTION

The present invention relates to an energy conservation incentivisation system wherein a customer supplies information demonstrating a reduction in total energy usage for a given period of time in relation to a corresponding period of time. The system then, upon verification of a reduction of energy usage, registers the customer in an applicable rewards program whereby the customer can win certain prizes, can receive a discount on their energy rate, and the like.

In another aspect of the present invention, the category or size of the applicable prize can be determined based upon the amount of conservation demonstrated by the customer. That is, a customer demonstrating a conservation of 20 percent from a first predetermined time in relation to a second predetermined time can be registered as eligible for more significant rewards than a customer demonstrating a 10 percent conservation for the same time period. Alternatively, a first customer conserving more energy than a second customer can receive additional entries into the rewards program. For example, a first customer conserving 20 percent of their energy usage could receive two (2) entries into the rewards program as opposed to a customer conserving 10 percent, thereby doubling the first customer's chance of winning.

In one embodiment of the present invention, the energy conservation incentivisation system can be implemented via a website having a web server and/or various other servers, such as a database server, back-end server communication server, or the like. The customer can electronically submit information relating to their energy usage, e.g., a scanned copy of their energy bill saved as a portable document format (PDF), image file or the like. Alternatively, the customer can fill out online forms hosted by the web server information indicative of their energy usage. In this alternative, the web server would be able to verify the customer entered information with the applicable energy supplier using the communication server and/or the database server.

In another embodiment of the present invention, the energy conservation incentivisation system can be implemented via a service provider using a standalone computer system wherein the customers submit information relating to their energy usage directly to the service provider. For example, a customer can submit their energy bills directly via mail or fax to the service provider who then enters the customer's information into the stand alone computer system. In this embodiment, the standalone computer system then compares the customer's energy usage to determine eligibility in the rewards program.

Other advantages of the presently disclosed invention will be apparent to one having ordinary skill in the art.

### BRIEF DESCRIPTION OF THE DRAWINGS

FIG. 1 is a block diagram of an energy conservation incentivisation system constructed in accordance with the present invention embodied via a web server communicating with the Internet.

FIG. 2 is a block diagram of an energy conservation incentivisation system constructed in accordance with the present invention embodied via a standalone computer system.

FIGS. 3A and 3B cooperate to illustrate an example of a utility bill for a time period between Jun. 26, 2008 and Jul. 30, 2008.

FIGS. 4A and 4B cooperate to illustrate an example of a utility bill for a time period between Jun. 29, 2009 and Jul. 31, 2009.

### DETAILED DESCRIPTION OF THE INVENTION

After considering the following description, those skilled in the art will clearly realize that the teachings of our present invention can be utilized in any one of an extremely wide range of applications where energy conservation incentivisation is needed. Therefore, the embodiments described herein are provided as examples only and are not meant to limit the scope of the present invention in any manner.

“Energy conservation,” in this instance and as the term will be used hereinafter, is defined as generically encompassing all utilities provided by utility providers. Examples of such utilities include, but are not limited to, electricity, natural gas, water, petroleum based products, e.g., oil, gasoline, liquefied petroleum gas and the like, as well as other known utilities.

“Rewards program,” in this instance and as the term will be used hereinafter, is defined as generically encompassing any program which permits a customer to win something of value for achieving a particular event, here—energy conservation. The scope and nature of the rewards offered by the rewards program can vary as determined by the rewards provider. Examples of such rewards include, but are not limited to cash, prizes, discounts on products or services, and the like.

For purposes of simplification, the present invention is discussed in the context of use in a web server processing environment communicating over a network, such as the Internet. We will also discuss the present invention in the context of use as a standalone computer system.

### Web Server Processing Environment

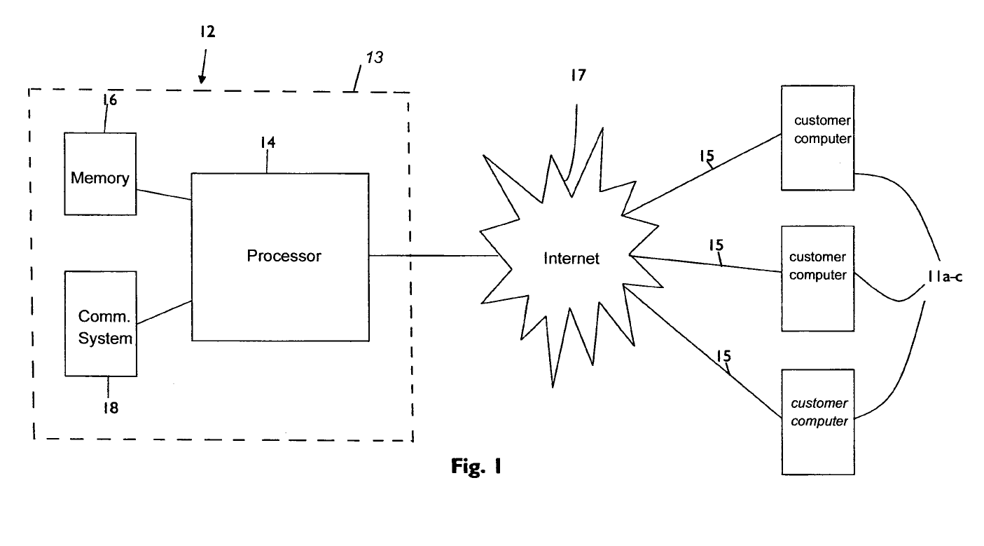

Referring now to FIG. 1, a computing environment contains a computer 13 which implements server 12, the latter illustratively being a web server. A number of individual remotely-located customer computers 11, each being illustratively a personal computer (PC), of which only three of are shown and identified by reference numerals 11a-c, are connected using appropriate communications channels 15 through a communications network, here shown as illustratively Internet 17, to computer 13. A user (not specifically shown), stationed at customer computer 11 and desiring to enter energy usage information to the server 12 can invoke a webpage, using a web browser running on the customer computer 11. The webpage resides within and is executed by the server 12. As would be understood within the art, any known web browser can be utilized to receive and display the information residing on the server 12 to the customer computer 11.

The server 12 includes, illustratively, a processor 14, a memory 16 and a communications system 18. The processor 14 can be implemented, for example, as any known processer which reads electronic information, processes such information and then provides results based on the processed information. Examples of such processors 14 are well known in the art and therefore will also not be described herein. Memory 16 stores information received from customer computer 11. Known memory types include, but are not limited to, solid-state memory, tape memory, hard disks, optical drives and the like. Communications system 18 communicates with the Internet 17 using a variety of internet and/or web protocols. Examples include, but are not limited to TCP/IP, HTML, DHCP, FTP, PPP, and the like.

Using the web page, the customer can enter information relating to their energy usage for storage and processing by the server 12. In a preferred embodiment of the present invention, the user can upload an electronic file relating to their energy usage for a period of time. The electronic file can be in a portable document format (PDF), image file, data file, or the like. For example, the customer can scan the utility bill they have received from their utility company which shows their energy usage for the period of time, e.g., for the previous month, and then save the scanned file in any of the above mentioned formats to be uploaded to the server 12. In another embodiment of the present invention, the customer simply inputs their energy usage information directly into an online form provided by the server 12. In this instance, the server 12 stores the customer's information in the memory 16.

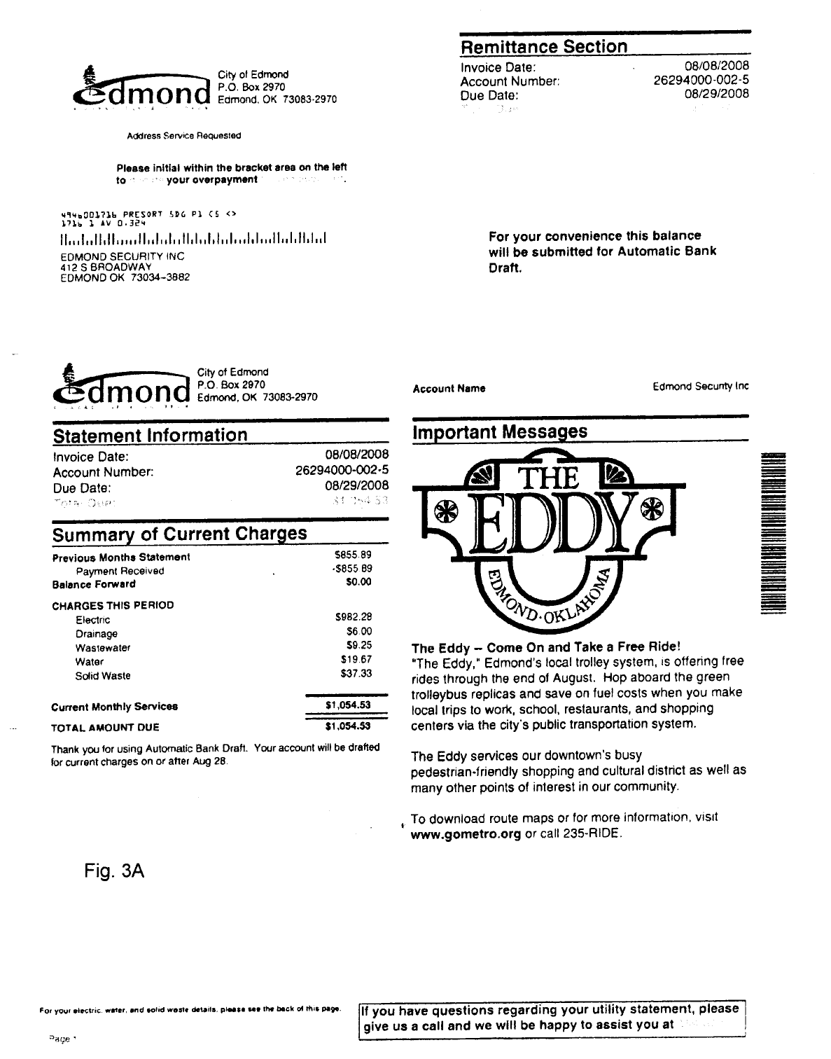

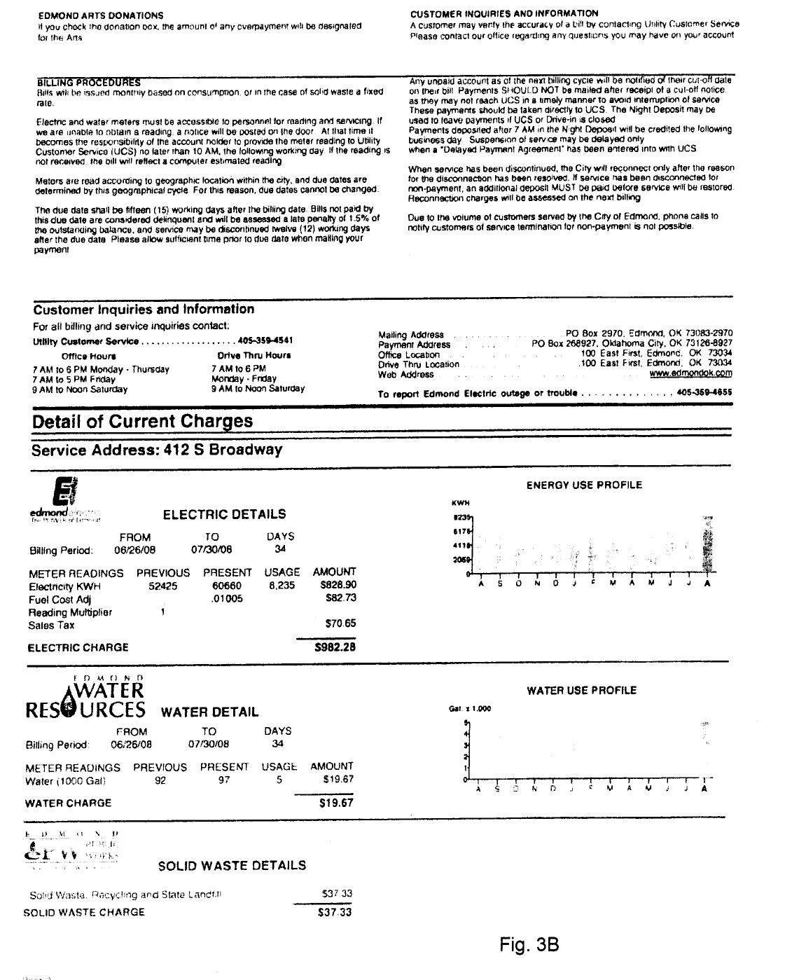

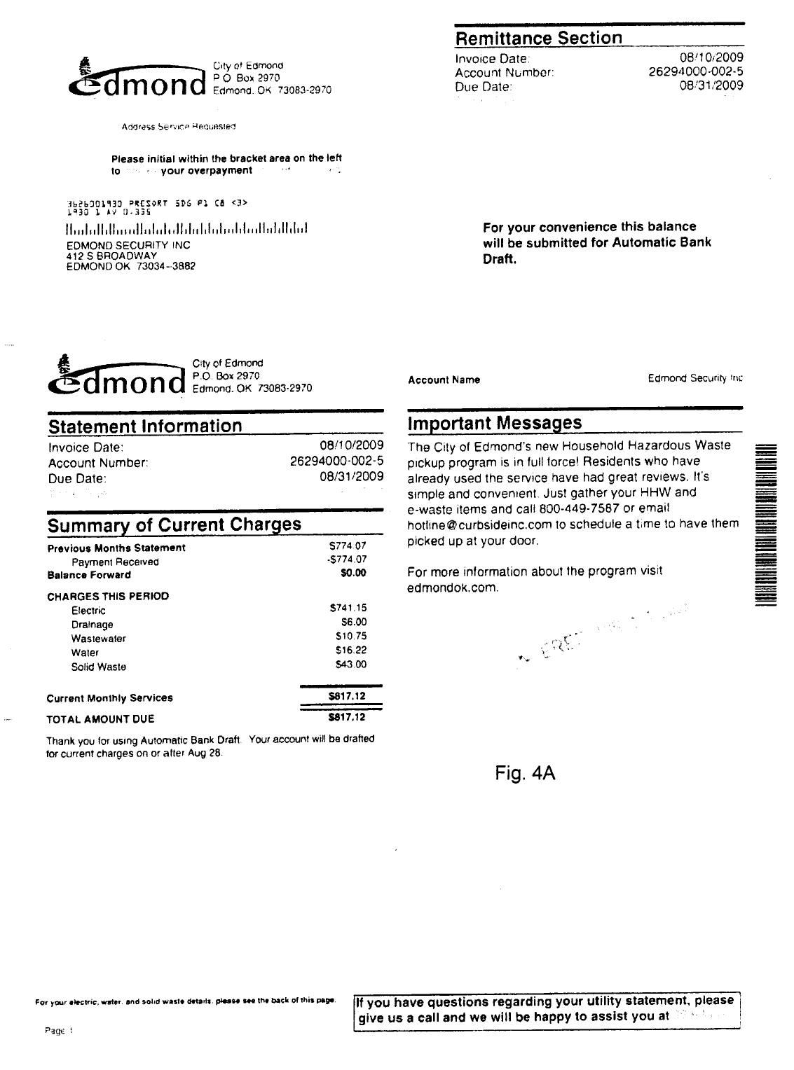

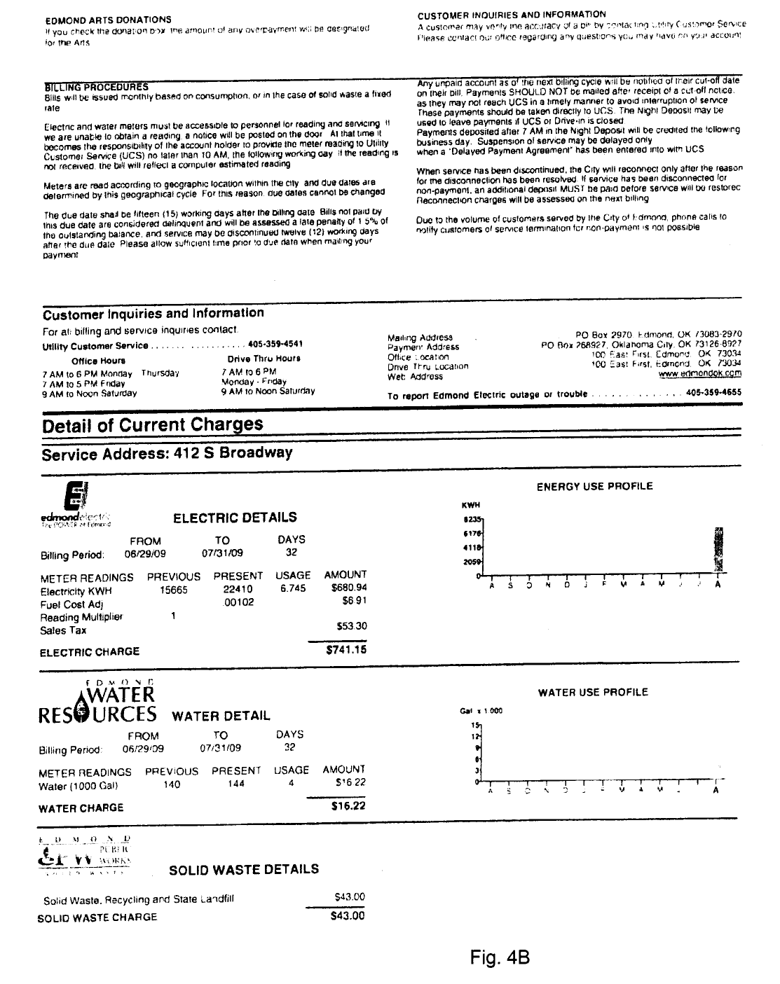

Once the customer's information is entered, or uploaded, the computer 13 reads the information contained in the electronic file in order to ascertain the customer's energy usage for the period of time. The computer 13 then stores the information from the customer's electronic file in memory 16. As would be understood, a customer entering their energy usage information on a regular recurring basis would have provided the computer 13 with a historical reference point from which to measure and compare the customer's current energy usage. Alternatively, a customer can also enter information relating to their energy usage for a previous period of time concurrently with their current energy usage information. For example, a customer can provide to the computer 13 an electronic copy of their energy bill for July 2009 (See FIGS. 4A and 4B) and at the same time provide an electronic copy of their energy bill for June 2009, July 2008 (See FIGS. 3A and 3B), or whatever time period desired, in which to compare and contrast their current energy usage with. In this manner, the computer 13 will have a plurality of energy usage time events from which to measure the consumer's energy usage and conservation.

When the computer 13 has received the customer's energy usage information, the computer 13 may optionally normalize the energy usage information by day or other appropriate time period to take into a difference different numbers of days (e.g., 34 days as shown in FIG. 3B; compared to 32 days as shown in FIG. 4B) within a given time period, and then compare the normalized current energy usage with normalized previous energy usage. Then, a determination is made relating to the rewards the customer may be entitled to. In one example, a customer can be entered into a rewards program when their energy usage during the current time period, as compared to a corresponding previous time period, comparing the customer's energy usage from July 2009 with their energy usage during July 2008 for example, is at least ten (10) percent less than a corresponding previous time period.

As would be understood in the art, the amount of rewards available to a customer conserving energy will depend on a variety of factors, as determined by the rewards provider. For example, a customer can qualify for greater rewards as they conserve larger amounts of energy. Additionally, the customer's chances of winning can also be based upon the amount of energy conserved. Generally, the level of rewards offered and the manner in which such rewards are offered will be determined by the rewards provider per their criteria.

### Standalone Computer Description

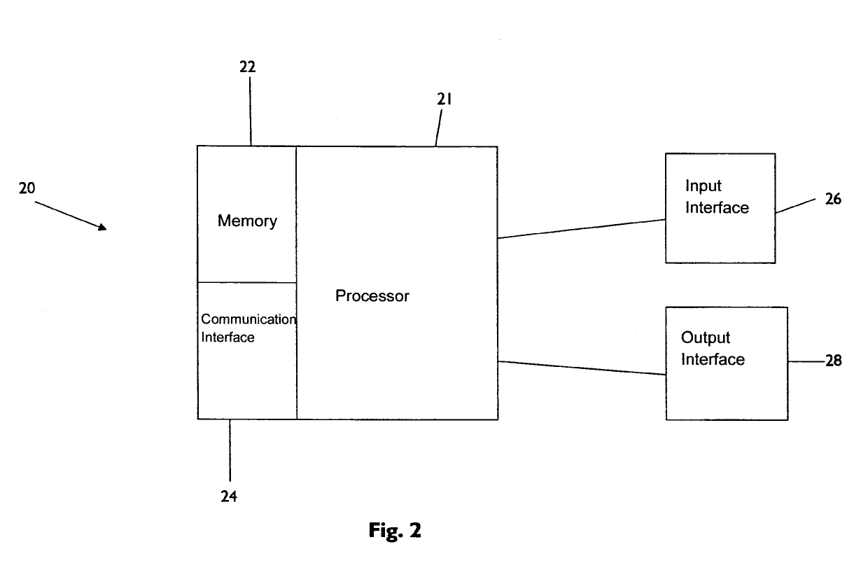

Referring now to FIG. 2, standalone computer 20 (which may be referred to herein as a “computer system 20”) comprises processor 21, memory 22, communications interface 24, input interfaces 26, and output interfaces 28. Memory 22, which generally includes different modalities, including illustratively random access memory (RAM) for temporary data and instruction store, diskette drive(s) (or flash memory) for exchanging information, as per user command, with floppy diskettes or a portable driver, and non-volatile mass storage that is implemented through a hard disk, typically magnetic in nature, although flash type memory components may likewise be utilized in accordance with the present invention.

As shown in FIG. 2, incoming information can arise from two illustrative external sources: network supplied information, e.g., from the Internet and/or other networked facility, through communications interface 24, or from a dedicated input source to input interfaces 26. Dedicated input can originate from a wide variety of sources, e.g., an external data source. In addition, input information, in the form of files or specific content therein, can also be provided by inserting a diskette or flash drive containing the information into a diskette drive from which computer system 20, under user instruction, will access and read that information from the diskette. Input interfaces 26 contains appropriate circuitry to provide necessary and corresponding electrical connections required to physically connect and interface each differing dedicated source of input information to computer system 20. Under control of the operating system, application programs exchange commands and data with the external sources to transmit and receive information typically requested by a user during program execution.

Input interfaces 26 also electrically connect and interface user input devices, such as a keyboard, mouse, scanner and the like, to computer system 20. The output interfaces 28 provide requisite circuitry to electrically connect and interface, for example, a display and printer to the computer system 20. As one can appreciate, our present inventive technique can operate with any type of digital information regardless of the modalities through which computer system 20 will obtain that information, store and/or communicate that information.

The present invention, when embodied in the standalone computer system 20, operates in substantially the same manner as the web server based system described above. That is, in this embodiment, the customer provides their energy usage information to the service provider via hard copy, e.g., via U.S. Postal Service or the like. Alternatively, the customer can provide a hard copy of their energy bill via facsimile to the service provider. Once received, the service provider can manually enter the customer's energy usage information into the computer system 20, which then performs the same functionality as the web server described above. That is, the standalone computer 20 then compares the customer's energy usage for a first time period with their energy usage for a second corresponding time period and then, based on the amount of energy conserved, enters the customer into a rewards program.

### Preferred Embodiment of the Invention

In a preferred embodiment of the invention, the energy conservation incentivisation system is implemented as a website having a web server wherein the customer enters or otherwise uploads information representative of their energy usage, preferably via an electronic PDF copy of their utility bill, to the website. The website reads the customer's information and then compares the customer's energy consumption for a fixed period of time, for example one month, with the customer's previous energy usage for a similar previous period of time, to determine when the customer has conserved energy. If it is determined that the customer has conserved energy, the customer can be entered into a rewards program wherein they are eligible to win a variety of rewards, as determined by a rewards provider.

As would be understood in the art, the term “Computer System” or “Computer” as used herein means a system or systems that are able to embody and/or execute the logic of computer executable instructions adapted to implement the processes described herein. The logic embodied in the form of computer executable instructions, e.g., software instructions or firmware may be executed on any appropriate hardware which may be a dedicated system or systems, or a general purpose computer system, or distributed processing computer system, all of which are well understood in the art, and a detailed description of how to make or use such computers is not deemed necessary herein. When the computer system is used to execute the logic of the processes described herein, such computer(s) and/or execution can be conducted at a same geographic location or multiple different geographic locations. Furthermore, the execution of the logic can be conducted continuously or at multiple discrete times. Further, such logic can be performed about simultaneously with the capture of the images, or thereafter or combinations thereof.

From the above description, it is clear that the present invention is well adapted to carry out the objects and to attain the advantages mentioned herein as well as those inherent in the invention. While presently preferred embodiments of the invention have been described for purposes of this disclosure, it will be readily understood that numerous changes may be made which will readily suggest themselves to those skilled in the art and which are accomplished within the spirit of the invention disclosed.

What is claimed is:

1. An energy conservation incentivisation system, comprising:
a website having a web server reading information representative of a customer's energy usage for a given period of time in relation to a corresponding period of time, verifying a reduction of energy usage, and registering the customer in a rewards program; and a communication system communicating with an Internet using an internet protocol to receive the information from the customer.

2. The energy conservation incentivisation system of claim 1, wherein a category of an applicable prize of the rewards program is determined based upon an amount of reduction of energy usage demonstrated by the customer.

3. The energy conservation incentivisation system of claim 1, wherein a size of an applicable prize is determined based upon an amount of reduction of energy usage demonstrated by the customer.

4. The energy conservation incentivisation system of claim 1, wherein the customer is a first customer conserving more energy than a second customer, and wherein registering the customer in the rewards program includes the first customer receiving more entries into the reward program than the second customer.

5. The energy conservation incentivisation system of claim 1, wherein the information received from the customer includes at least one electronic file of the customer's utility bill for the given period of time, and the customer's utility bill for the corresponding period of time.

6. A computer, comprising:
a processor;
a non-transitory memory storing computer executable instructions to cause the processor to:
store information received from a customer, where the information is representative of energy usage by the customer for a given period of time in relation to a corresponding period of time,
verify a reduction of energy usage for the given period of time in relation to the corresponding period of time by comparing the energy usage by the customer for the given period of time to the energy usage by the customer for the corresponding period of time, and
register the customer into a rewards program based upon the verification in the reduction of energy usage;
wherein the processor reads and executes the computer executable instructions stored in non-transitory memory; and
a communication system receiving the information from the customer via a network using an internet protocol.

7. The computer of claim 6, wherein the information received from the customer includes at least one electronic file of the customer's utility bill for the given period of time, and the customer's utility bill for the corresponding period of time.

8. A non-transitory memory storing computer executable instructions that when executed by a computer cause the computer to:
(a) read energy usage information received from a customer, by a communications system via a network using an internet protocol, the energy usage information representative of a customer's energy usage for a given period of time in relation to a corresponding period of time;
(b) determine whether the customer has conserved energy by comparing the customer's energy consumption for the given period of time in relation to a corresponding period of time; and
(c) if the customer has conserved energy, register the customer into a rewards program.

9. The non-transitory memory storing computer executable instructions of claim 8, wherein the energy usage information is normalized by an appropriate time period taking into account differing lengths of time between the given period and the corresponding period of time.

10. The non-transitory memory of claim 8, wherein the energy usage information includes an electronic copy of the customer's utility bill for the given period of time, and an electronic copy of the customer's utility bill for the corresponding period of time.

11. An energy conservation incentivisation system, comprising:
a web server providing a webpage to a customer's computer via an Internet for prompting the customer to enter energy usage information;
a communication server receiving the energy usage information from the customer's computer via the Internet;
a database server receiving the energy usage information from the communication server and verifying a reduction in energy usage with an applicable energy supplier and registering the customer into a rewards program responsive to the verification of the reduction in energy usage exceeding a predetermined amount.

12. The energy conservation incentivisation system of claim 11, wherein the energy usage information is received by the communication server in a form of one or more electronic files.

13. The energy conservation incentivisation system of claim 11, wherein the webpage includes an online form, and wherein the energy usage information is received from the customer's computer via the online form.

14. The energy conservation incentivisation system of claim 11, wherein the database server creates and stores a historical reference point from the energy usage information received from the customer's computer.
